(19) United States
(12) Patent Application Publication
(10) Pub. No.: US 2001/0051951 A1
(43) Pub. Date: Dec. 13, 2001

(54) Data processing system for charge calculation

(75) Inventor: Hidenori Nishikawa, Tokyo-to (JP)

Correspondence Address: INTERNATIONAL BUSINESS MACHINES CORPORATION, INTELLECTUAL PROPERTY LAW, DEPT. QPZA/ 210, 8501 IBM DRIVE, CHARLOTTE, NC, 28262, US

(73) Assignee: International Business Machines Corporation, Armonk, NY (US)

(21) Appl. No.: 09/742,660

(22) Filed: Dec. 21, 2000

(30) Foreign Application Priority Data
Dec. 28, 1999 (JP) 11-375559

(51) Int. Cl. G06F 17/30

(52) U.S. Cl. 707/104.1; 707/1

(57) ABSTRACT

The present invention provides a data processing system that can flexibly perform calculation processes for an application service for which the charge calculation methods for customers are frequently changed. The present invention employs a charge calculation method for which a rule is used. In a conventional calculation method of table driven method, only those variable data that are required for a calculation are provided externally; whereas in the present invention, not only is such a data part provided, but also the logic part (the procedures part) of a program are externally provided as a rule. Specifically, the system of the invention comprises a discount ratio designation table (discount table) and a rule management unit in which are stored rule sets for the calculation of a charge/discount ratio for a corresponding service. In accordance with the available data for a specific customer, a corresponding rule set is examined in the discount table and is employed for an operation. Thus, even when a new service is added or when the contents of a conventional service are changed, the system can flexibly and quickly cope with this by changing the rule.

### BACKGROUND OF THE INVENTION

1. Field of the Invention

The present invention relates to a data processing system that, in an application wherein a customer charge calculation method is frequently changed, flexibly performs calculations, and relates in particular to a data processing system that employs a rule for performing such calculations.

2. Description of the Related Art

Recently, as customer services have become ever more diversified, there are some business systems wherein for individual customers, in accordance with products that are purchased, with services that are provided or with purchase or usage records, a variety of charge rating methods or discount ratios are employed. Specifically, in some cases charges are defined as fixed charges, while in other cases charges are defined as usage-volume-based charges; or discount ratios are increased in accordance with predetermined usage records. According to another existing business system, a point assignment method is employed that awards to customers set point values, consonant with the customers records of purchase or of usage, so that the customers may acquire predetermined advantages that correspond, in essence, with the number of points that they have accumulated (hereinafter, the calculation of points, for which specific values are allocated, are included in the calculation of charges). To provide such a customer service (discount service, etc.), a charge/discount calculation program, which is based on customer data (event data) produced by previous purchases of products or services, is employed to calculate charges when specific products or services are purchased.

To calculate a telephone service charge, for example, in accordance with the contents of a customer transaction agreement, a calculation is performed based on the telephone number for which the customer made the contract, and corresponding call detail records (after called event data, which include the calling party's telephone number, the called party's telephone number, the dialing time of day (including the hour, minutes, seconds and smaller time units), and the conversation duration (including hours, minutes, seconds and smaller time units)). The charge/discount calculation program reads call detail records, examines all the discount services that are related to the call detail records, and calculates a charge by repeating a calculation process as often as necessary. When a plurality of calculations for discounts are required for one charge, the charge/discount calculation program may be used for all of them.

A charge/discount calculation program tends to be a large, complicated program that include modules having various structures. In addition, each time a new service is added, a conventional service is modified, a charging system is revised, or the organization of a customer is changed, the pertinent program must be changed or modified. In order to eliminate the complexity, the operation of an internal module of the calculation program is focused on, and one method has been proposed whereby data parts of the service specification that can be expressed numerically are translated into parameters, which are entered in an external table, that control the execution of the table driven method. According to this method, however, only variable data parts, such as charges, that can be easily expressed using numerals are translated to parameters that are provided externally.

### Problems to be Solved by the Invention

The above charge calculation method functions satisfactorily when only a few types of customer services, such as a discount service, are offered, and when a combination of the services offered is not complicated. However, when competition is keen, as at the present, and a variety of customer services (discount services, etc.) for differentiation must be sequentially provided, taking into consideration the flexibility of the above method and the degree to which it is susceptible to alteration, the functioning of the above method is not satisfactory. That is, since each time a new, complicated service is to be introduced, a huge program modification must be made and numerous tests must be conducted, accordingly, the release of the service can not help but be delayed.

Even when a table driven method using an external table is constructed, parameters become more complicated each time a new service is added, so that understanding the features offered by the service and providing maintenance for the service are extremely difficult. Further, according to this method, since only the data part in a service specification that can be expressed as numerals are translated to parameters and provided externally, while the procedures part for handling the data are unchanged, a modification or an addition to the charge/discount calculation program can not be avoided.

In addition, no environment is provided that can facilitate the establishment of an area of understanding between a person who plans a customer service, such as discounting, and prepares the specifications for it, and a person who defines the operating conditions for the calculation program and develops it based on the specifications, so that a greatly extended period of time is required to develop a program. That is, to introduce a service quickly, a mechanism is required that can provide for the implementation of specifications as soon as they have been prepared.

To resolve the above shortcoming, it is one object of the present invention to provide a data processing system that can quickly and flexibly cope with the addition of a customer service, one for which a new and complicated combination of charge calculations is required.

### SUMMARY OF THE INVENTION

To achieve the above object, the data processing system of the present invention employs a rule driven charge calculation method, whereby a rule is employed for charge calculation. While the basic idea of a calculation system of the table driven method is that only variable data required for a calculation are provided externally, the basic idea of the present invention is that not only such a data part, but also a logic part (a procedure part) is externally formed to obtain a rule. Further, in the present invention, calculations are performed not only for each telephone number or for each event data, but for each customer who is a service contractor or for each service.

Specifically, according to the present invention, a data processing system for the calculation of charges for customers comprises: a database, in which customer data required for the calculation of charges are managed; rule management means, for storing, in advance, a rule defining a charge calculation method that is employed in accordance with the type of a customer service; and calculation means, for, in accordance with the contents of the customer data read from the database, obtaining the rule for a pertinent customer from the rule management means, and for calculating a charge. Further, in this system, a discount table, described in the rule, can be provided in which a charge discount ratio is stored for use for charge calculations in accordance with the contents of a customer service. In this case, the calculation means calculates charges by referring to the designated discount ratio in the operating rule.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative detailed embodiment and when read in conjunction with the accompanying drawings, wherein:

FIG. 1 is a block diagram for explaining a charge calculation system that employs a rule driven method according to the present invention.

FIG. 2 is a block diagram for explaining a conventional charge calculation system.

FIG. 3 is a diagram for explaining a charge calculation process for which a table driven method is used.

FIG. 4 is a diagram for explaining the charge calculation process for which the rule driven method of the present invention is used.

FIG. 5 is a diagram for explaining specific, example rule sets for a discount condition process and for the calculation of discounts.

FIG. 6 is a diagram showing actual calculations performed for discounts using the rule based instructions and the discount table.

While the invention will be described in connection with a preferred embodiment, the description is not intended to limit the invention to that embodiment. On the contrary, the invention is intended to cover all alternatives, modifications and equivalents as may be included within the spirit and scope of the invention as described by the appended claims.

### DETAILED DESCRIPTION OF THE INVENTION

To easily understand the present invention, the preferred embodiment will be described by using a charge/discount calculation system to determine a telephone charge. It should be noted, however, that this system is used in the explanation merely for convenience sake, and that the present invention can be applied for other system applications for which are required a variety of charge calculations and point calculations, in accordance with the type of the customer service (e.g., various mail order sales or frequent flier mile calculations provided by air line companies).

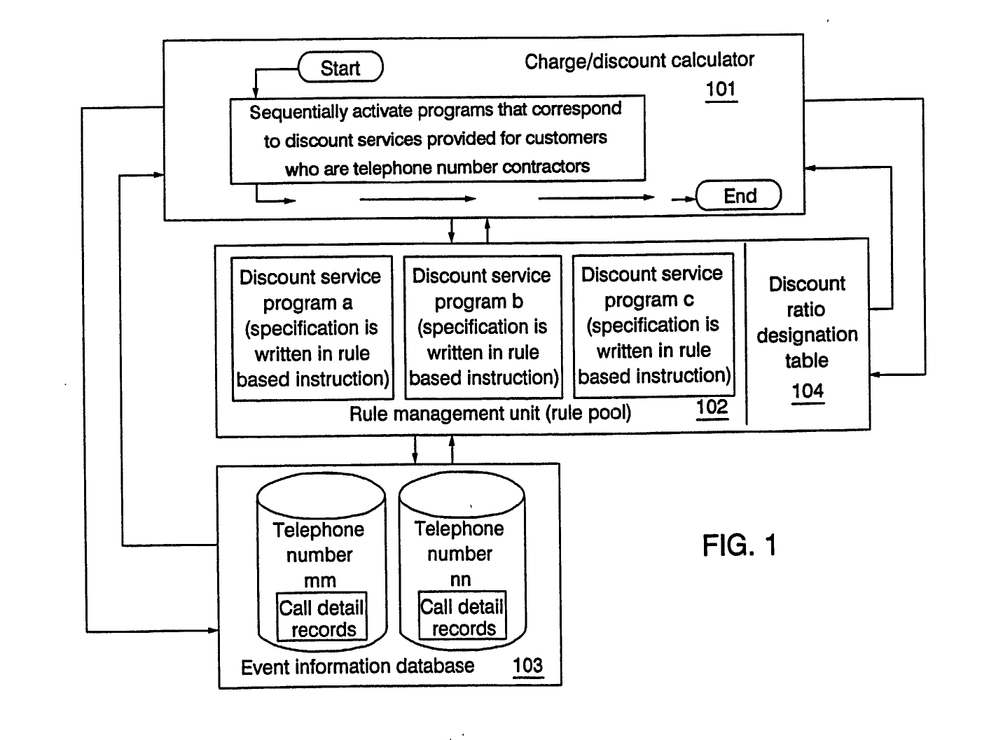

FIG. 1 is a block diagram for explaining a charge calculation system using the rule driven method of the present invention, and

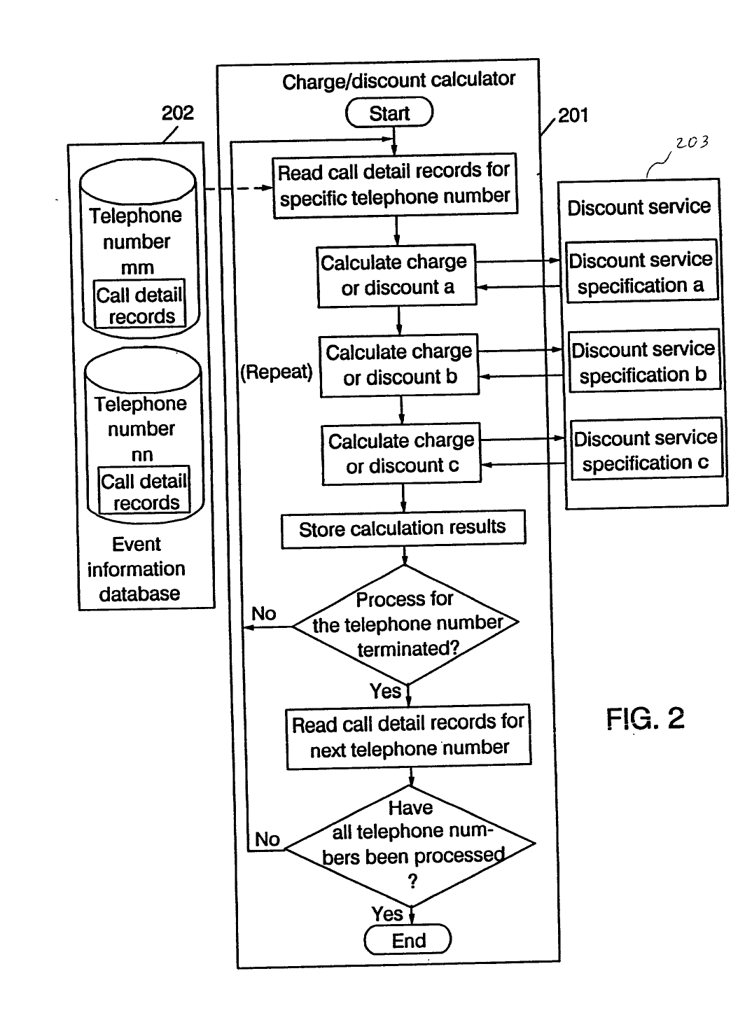

FIG. 2 is a block diagram for explaining a conventional charge calculation system.

First, the conventional system in FIG. 2 will be explained. In this system, based on a telephone number for which a customer has entered into a contract, a charge/discount calculator 201 reads, from an event information database 202, corresponding call detail records (a calling party's telephone number, a called party's telephone number, a dialing time of day (including the hour, minutes, seconds and smaller time units), a conversation duration (including hours, minutes, seconds and smaller time units)). The calculator 201 examines all the discount services (services a to c), block 203, that the call detail records are related to, and calculates the charge, and repeats this process as often as necessary. Since the calculator 201 of this system stores all the logic parts (programs) required for charge calculations, the program must be modified when a new discount service is added or the contents of a discount service is changed.

In the system of the present invention in FIG. 1, a charge calculator 101 performs a necessary discount/charge calculation for each customer/each service. For each discount service, the calculator 101 reads, from event information database 103, accumulated event data (call detail records, aggregate results, etc.), and calculates a charge for these data. It then, in effect, prepares a data catalog for each customer that it stores in the event information database 103. With this data catalog, calculations can be flexibly performed, even when the organization of the customer is changed. Upon the receipt of a rule based instruction, or as needed, the calculator 101 employs an associated table to perform a calculation. The rule based instruction is one that is prepared in advance using an easy language that is especially prepared for use with predetermined calculations, such as calculations for discounts. The specifications for various discount services are written using the rule based instruction, and are implemented as a small program. That is, calculations required for individual discount services are performed by using a program that was written using the rule based instruction. A program module written using the rule based instruction is also called a rule set (group), and such a rule set is stored in a rule management unit (rule pool) 102. If necessary, a discount ratio designation table (discount table) 104 can be referred to for each rule, and a variable discount ratio can be separately designated in a rule based instruction. With this arrangement, even when a new service is added or the contents of a conventional service are changed, to quickly and flexibly cope with such an alteration, only a small portion, such as a rule or a table, must be modified. As a result, a calculation system that is superior to the conventional system can be provided. The rule and the table will be specifically described later.

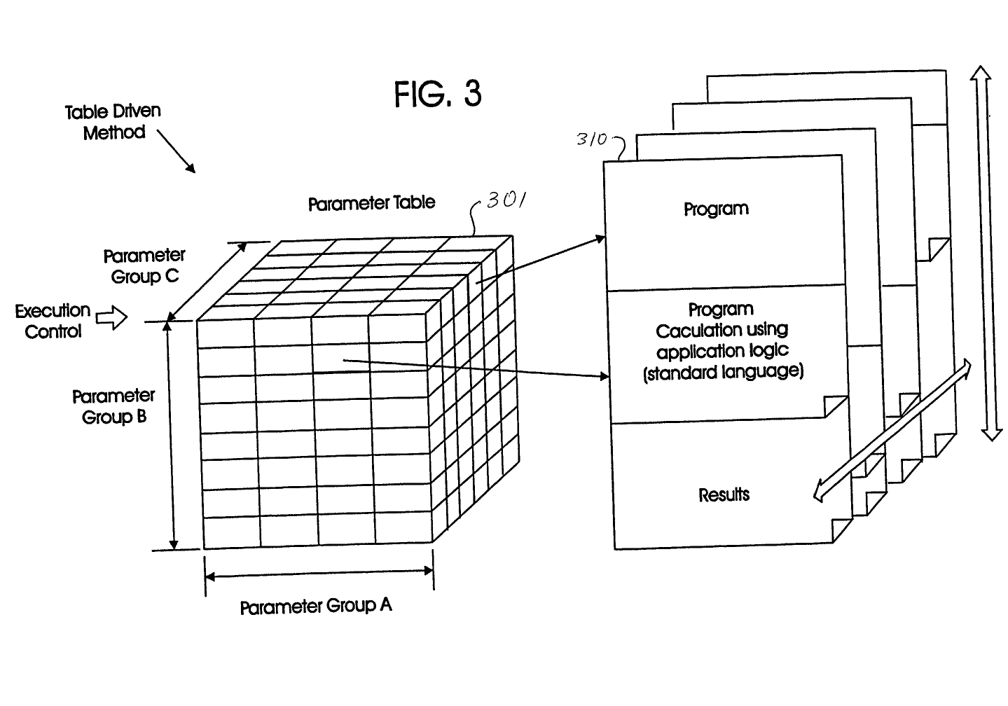

FIG. 3 is a diagram for explaining the charge calculation process performed by the table driven method. In FIG. 3, provision is made for the management of three parameters, A to C, in an external table, as data parts of the service specifications that can be expressed by numerals. Programs, such as block 310, that perform the calculation processes that are required for various services obtain necessary values from the table by specifying individual parameter values. Although this system can flexibly cope with changes in the parameter values, a parameter table tends to become complicated when a service is added or the contents of a service are changed. Further, since the logic part of a program that performs a calculation must be changed, this system can not quickly and flexibly cope with the addition of, or a change in, a service.

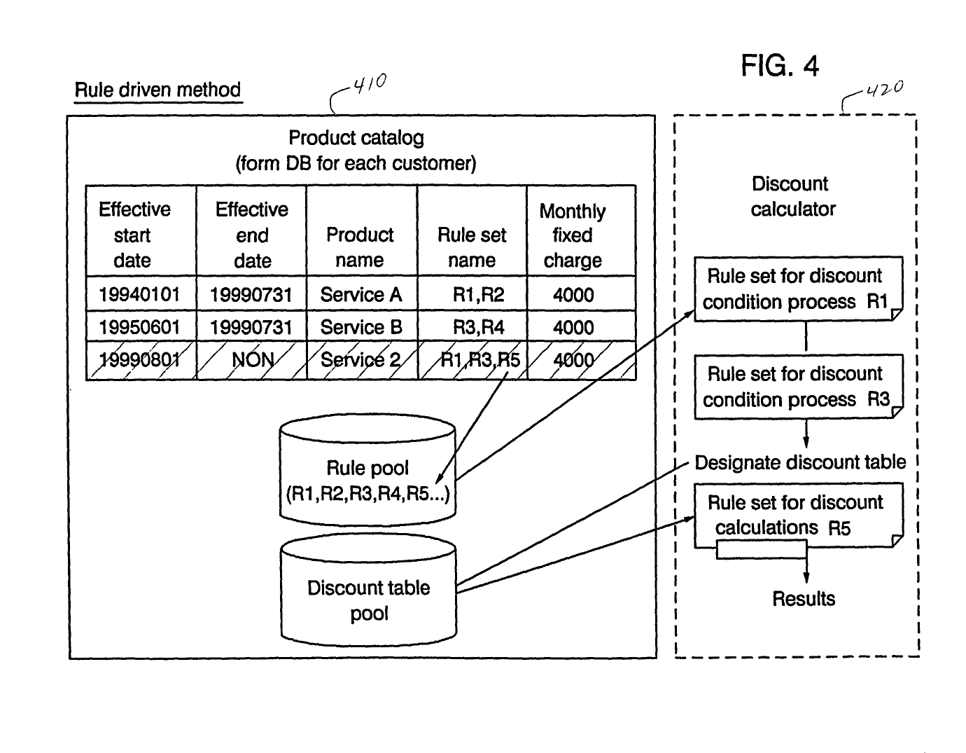

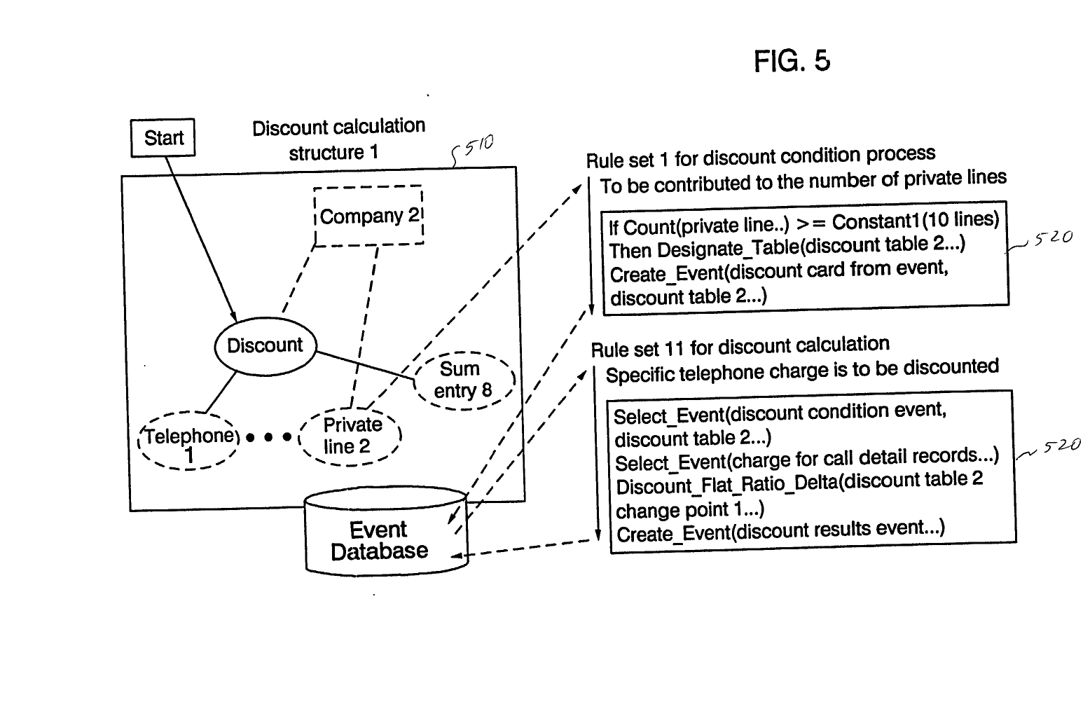

FIG. 4 is a diagram for explaining the charge calculation process, block 410, using the rule driven method of the present invention. In this invention, rule sets for a discount condition process (R1, R3, etc.) and rule sets (R5, etc.) for calculations for discounts, although prepared as separate entities, function together with a discount ratio designation table (discount table) as a discount calculation program, block 420. To provide a new discount service, either a small portion (a rule set or the table) must be modified in order for it to be used for a new calculation program, or a new rule based instruction must be employed to prepare a new rule set. Since the rule based instruction can be written in an easy language that is especially employed for calculations, such as the calculation of a discount, only a short period of time is required to prepare a rule set or to conduct a test. Furthermore, since the rule based instruction can be written in an easy language, the creator of the specifications for a discount service can also prepare a program for the service, so that the problem related to the establishment of an area of understanding between a creator of specifications and a program developer can be eliminated.

An example rule set (a combination of rule based instructions) used for this embodiment will be described below. In this example, an explanation will be given for the types of rule based instructions by which the specifications for a discount service can be implemented to provide a specific application. The preparation of rule sets, however, is not limited by the foregoing, and based on the technical idea of the present invention, other instruction sets or rule sets, which are appropriate for other applications, can be prepared as needed.

The following rule based instructions are prepared as a rule set to create a discount condition. Count_Number (count the number).

Aggregate_Length (the aggregate of lengths)

Check_Flag (examine a flag)

Designate_Table (designate a table)

Create_Event (create an event)

The following rule based instructions are created as a rule set for the calculation of a discount.

Add_Constant (add an initial value/minimum guaranteed value)

Discount_Flat_Ratio_Delta (apply a discount ratio for a difference that exceeds a change point)

Discount_Flat_Ratio_Accumulate (do not apply a discount ratio to a difference that exceeds a change point, but instead, apply it retrospectively to an overall accumulated value (optimal))

Discount_Constant_Last (discount a predetermined value determined at the last change point)

The following rule based instructions are prepared as a rule set for the calculation of charges.

Add_Constant (add an initial value/minimum guaranteed value)

Rate_Delta (calculate a charge for a difference that exceeds a change point (rating))

Rate_Accumulate (do not calculate a charge for a difference that exceeds a charge point, but instead, calculate it retrospectively for all values accumulated since the original point (optimal))

Referring again to FIG. 4, as is apparent from the contents of the catalog data for a specific customer, services A and B have been provided, and currently service Z is being provided. The rule sets R1, R3 and R5 are designated for the release of the service Z. The discount calculator 101 calculates discounts by activating these rules in the rule pool 102, and, as needed, refers to the discount tables 104 that are designated in these rules.

FIG. 5 is a diagram for explaining a more specific example of rule sets, such as block 520, for the discount condition process, block 510, and the calculation of discounts. In FIG. 5, a rule group “discount 1” is employed for a company 2, and as a result, a rule set 1 for the discount condition process and a rule set 11 for the calculation of discounts are activated. In this example, when the number of private lines for the company 2 exceeds 10, a discount table 2 is designated, and based on this table, a series of discount processes is performed.

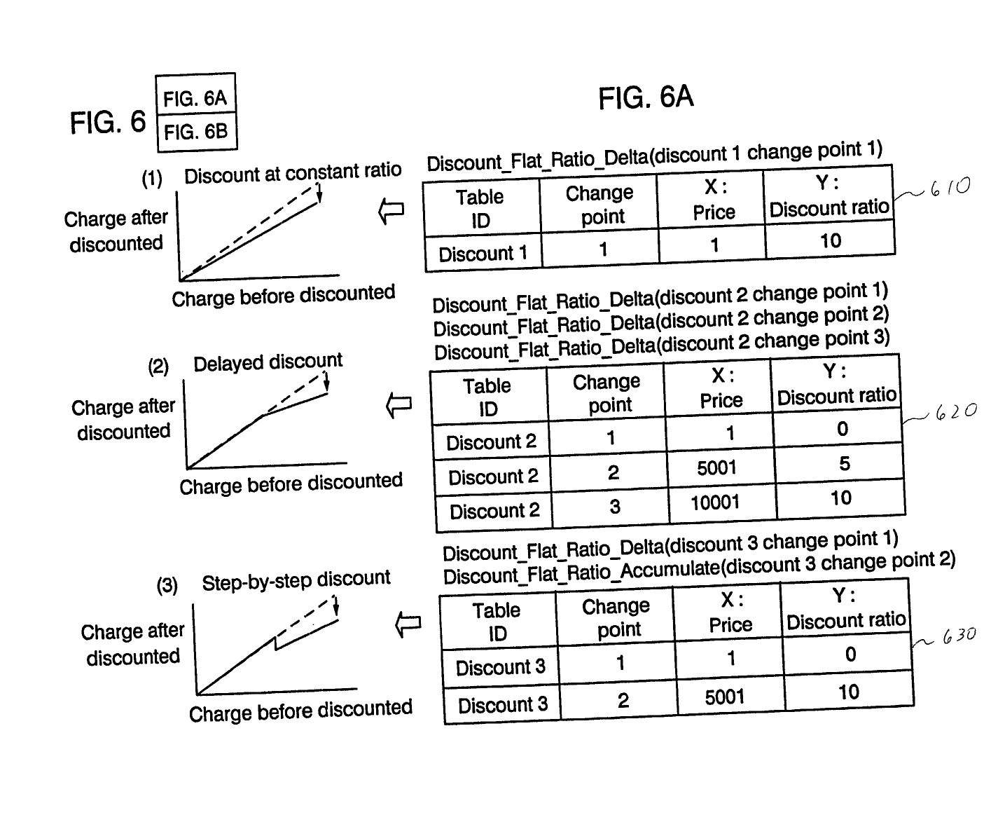

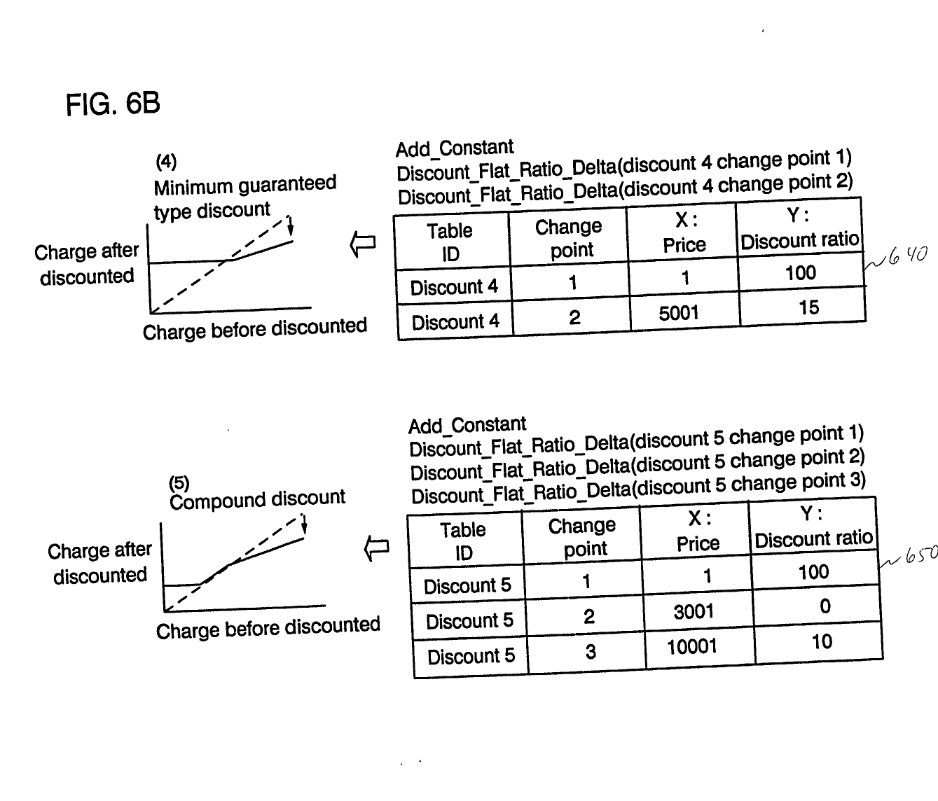

The discount table (discount ratio designation table) in this embodiment includes a change point number (change point identifier), a discount threshold value, and a discount ratio. The rule based instructions for processing these data need only designate, for the parameter field, the identifier of the discount table and the change point number (change point identifier). A specific, example discount table will be described later while referring to FIG. 6. With this arrangement, even the person who prepared the plans for a new discount service can easily write a rule set incorporating the specifications for the service. Further, if a program developer prepares a rule set, he or she does not have to define conditions or to perform coding (programming), and can immediately conduct a confirmation test for the operation. That is, by implementing the discount table of this invention and a corresponding rule set, a simple discount calculation method is provided that can flexibly cope with changes.

FIG. 6 consists of diagrams, blocks 610, 620, 630, 640 and 650, of actual examples of discount calculations performed using rule based instructions and discount tables, which are designated by using table IDs. The broken line in each graph represents a change in a charge before a discount is applied, and the solid line represents a change in a charge after the discount is applied. In (3), step-by-step discounting, a discount table 2 is designated in each rule based instruction. When a change point is 1, i.e., when the charge X falls within a range of from 1 to 5000 yen, discount ratio Y is 0 (no discount), while, when the change point is 2, i.e., when the charge X is equal to higher than 5001 yen, the discount ratio Y is 10%. Only typical cases are shown in FIG. 6; however, it would be easily understood that a variety of discount ratios can be set based on the technical idea of the invention.

### Advantages of the Invention

As is described above, according to the present invention, a data processing system is provided that employs a predetermined rule to perform for a customer service a calculation process wherein a charge calculation method for each client is frequently changed. Therefore, this system can quickly and flexibly cope with the addition of a new service and with a change in the contents of a conventional service.

In addition, since the system of the present invention manages required data for individual customers, charges can be flexibly calculated, even though the organization of a customer is changed.

While the invention has been particularly shown and described with reference to a preferred embodiment, it will be understood that various changes in form and detail may be made therein without departing from the spirit and scope of the invention.

What is claimed is:

1. A data processing system for calculating charges to customers, comprising:
a database, for managing customer data required for calculating said charges to customers;
rule management means, for storing a rule that, in advance, defines a charge calculation method that is employed in accordance with the type of customer service that is rendered; and
calculation means, for, in accordance with the contents of said customer data read from said database, obtaining for a pertinent customer, from said rule management means, said rule that defines a charge calculation method, and for calculating a charge.

2. A data processing system for calculating charges to customers, comprising:
a database, for managing customer data required for calculating said charges to customers;
rule management means, for storing a rule that, in advance, defines a charge calculation method that is employed in accordance with the type of customer service that is rendered;
a discount table, which is described in said rule that defines a charge calculation method, for storing a charge discount ratio that is employed for said charge calculation in accordance with the type of customer service that is rendered; and
calculation means, for, in accordance with the contents of said customer data read from said database, obtaining for a pertinent customer, from said rule management means, said rule that defines a charge calculation method, and for calculating a charge by referring to said charge discount ratio defined in said pertinent rule.
